(19) United States
(12) Patent Application Publication
(10) Pub. No.: US 2006/0237973 A1
(43) Pub. Date: Oct. 26, 2006

(54) Momentary inertial latching device

(76) Inventor: Romain Anguila, Fenton, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/405,366

(22) Filed: Apr. 17, 2006

Related U.S. Application Data
(60) Provisional application No. 60/672,702, filed on Apr. 19, 2005.

(51) Int. Cl. E05B 65/10

(52) U.S. Cl. 292/92

(57) ABSTRACT

A momentary inertial latching device (MILD) includes a stop member and a mass in cooperation with one another. The stop member interrupts a path of a protrusion associated with a locking plate. Under normal vehicle operating conditions, the stop member is free to move relative to the mass, allowing the protrusion to travel along its path unimpeded. This allows the latching mechanism to actuate and an associated vehicle door to open. In the event of an impact or some other sudden acceleration or deceleration event, the mass moves to a second position wherein the stop member cannot move relative to the mass. In this position, the stop member prevents the protrusion from moving and prevents the latching mechanism from actuating and the vehicle door from being opened.

### CROSS-REFERENCE TO RELATED APPLICATION

This application claims priority to U.S. Provisional Application No. 60/672,702 which was filed on Apr. 19, 2005.

### TECHNICAL FIELD

This invention generally relates to door securing devices. More particularly, this invention relates to latching devices for doors.

### BACKGROUND OF THE INVENTION

Vehicle doors, liftgates and tailgates typically are secured by a latching mechanism. Certain vehicle operating conditions, however, such as an impact or other sudden acceleration or deceleration tend to overpower the ability of the latching mechanism to keep the door closed. As such, there is a need for a device that prevents the latching mechanism from allowing the vehicle door to open under such conditions.

It is known to incorporate inertial latching devices into existing vehicle door latches to prevent the vehicle door from being opened under certain conditions. One example system, shown in U.S. Pat. No. 4,422,522, prevents a solenoid activated vehicle latch from activating. One shortcoming of known inertial latching devices is that they are substantially integrated into the latching mechanism, itself. This requires an all new latching device and would require retrofit to incorporate the additional latching feature. Additionally, most designs are specific to only one type of latch or lock. Those skilled in the art are always striving for improvements. There is a need for an improved device to keep a door or other panel secured in a closed position that is not as limited as previous designs.

### SUMMARY OF THE INVENTION

An exemplary momentary inertia latching device (MILD) includes a stop member and a mass member in cooperation with one another. In a first position, the mass member is aligned with the stop member to at least partially receive a portion of the stop member as the stop member moves. The mass member is moveable in a second position that prevents the stop member from moving. When the stop member moves, it allows an associated locking mechanism to open. When the stop member cannot move, it prevents the associated locking mechanism from opening.

One example mass member includes an opening that is aligned with the stop member in the first position to receive the portion of the stop member as it moves. The opening is offset from the portion of the stop member in the second position such that the stop member abuts against the mass member in the second position.

One example MILD includes a first spring that biases the stop member away from the mass member and a centering member. The centering member includes a centering spring and a ball. The mass member includes a contour for at least partially receiving the ball and the centering member biases the mass member into the first position. A weight of the mass member overcomes the centering member bias if the mass member sufficiently accelerates and consequently moves toward the second position.

These various features and advantages of the present invention can be best understood from the following description and drawings, of which the following is a brief description.

### BRIEF DESCRIPTION OF THE DRAWINGS

FIG. 1 is a perspective, partially exploded view of selected portions of a latching mechanism designed according to an embodiment of this invention.

FIG. 2 is a detailed cross-sectional view of a momentary inertia latching device (MILD) of one example embodiment of the present invention.

FIG. 3 is a perspective view of another example MILD installed onto a latching mechanism.

FIG. 4 is a cross-sectional illustration showing one operating condition of the example MILD and latching mechanism.

FIG. 5 is a cross-sectional illustration showing another operating condition of the example MILD and latching mechanism.

### DETAILED DESCRIPTION OF THE PREFERRED EMBODIMENT

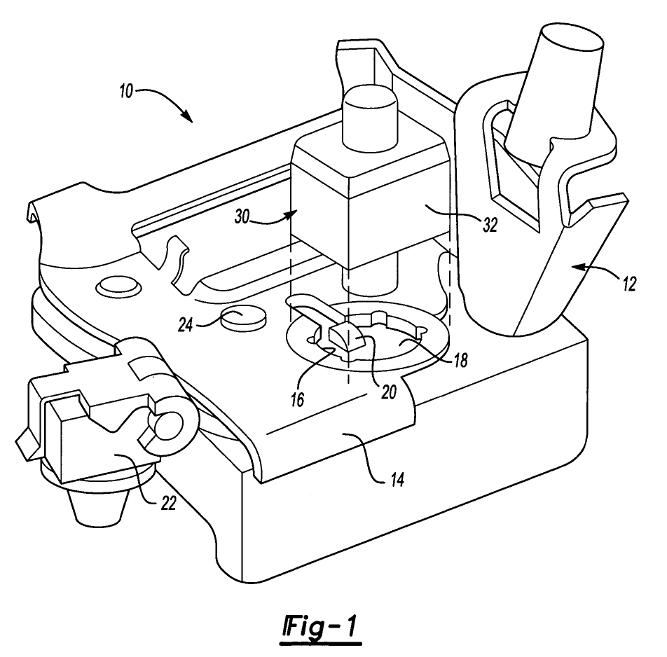

A perspective view of selected portions of a latching mechanism 10 is shown in FIG. 1. This example includes a lock 12 that operates in a generally known manner to secure a vehicle door in a closed position. The latching mechanism 10 includes a first locking plate 14 having an opening 16, which is unique to this example. A second locking plate 18 is located adjacent the first locking plate 14. The second locking plate 18 includes a protrusion 20 that is aligned with the opening 16 in the illustrated position. An actuator portion 22 of the latching mechanism 10 is associated with a door handle of a vehicle door, for example, in a known manner. Appropriate manipulation of the door handle causes the actuator portion 22 to rotate the second locking plate 18 about a pivot 24. As the second locking plate 18 rotates relative to the first locking plate 14, the latching mechanism 10 will release in a known manner, which allows an associated door to move into an open position. During such movement, the protrusion 20 follows an arcuate path (in a generally clockwise direction according to the Figure) and moves at least partially along the opening 16.

Under most circumstances, the lock 12 and actuator 22 are sufficient to keep a door closed. In some cases, the second locking plate 18 may inadvertently move and disengage the latching mechanism 10.

The example of FIG. 1 includes a momentary inertia latching device (MILD) 30 that presents unexpected operation of the latching mechanism 10. In this example, the MILD 30 includes a plastic housing 32 that is integrally molded as one piece with the locking plate 14.

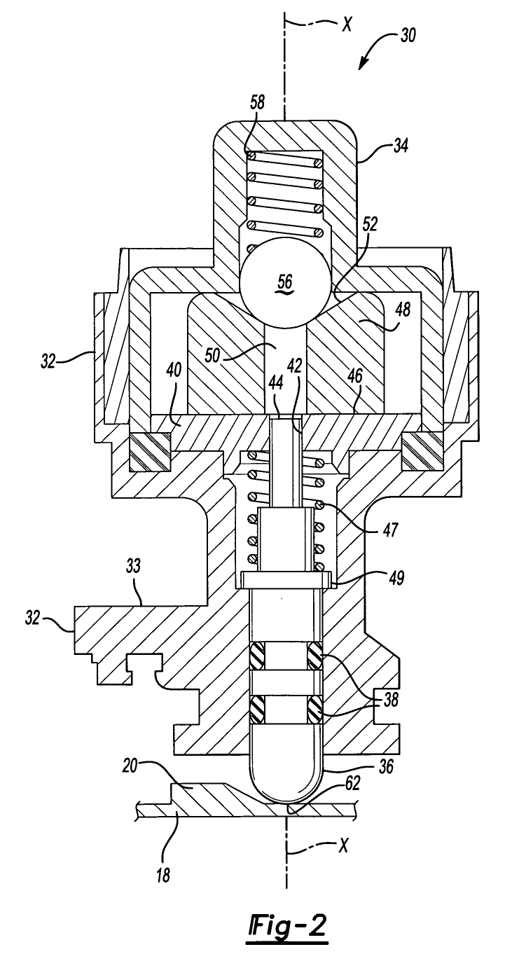

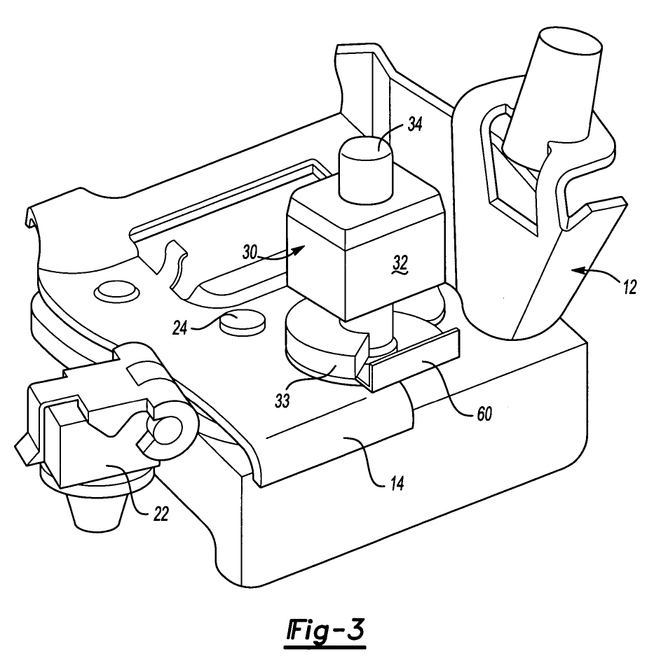

A cross-sectional schematic view of another MILD 30 is shown in FIG. 2. This example MILD 30 is shown in FIG. 3 in a position installed on the first locking plate 14 of a latching mechanism 10.

As can best be appreciated from FIG. 3, the external structure of the example MILD 30 includes a housing 32 and a mounting portion 33 that is secured against the plate 14 near a cover 34. A clip 35 secures the illustrated MILD 30 to the locking plate 14 of the latching mechanism 10.

A stop member 36, which is a pin or a plunger in this example, is disposed within the housing 32. 0-ring seals 38 are installed between the stop member 36 and the housing 32 to form a seal.

A plate 40 is located inside the cover 32 and includes a plate opening 42 that extends through the entire plate 40. The stop member 36 protrudes at least partially into the plate opening 42 such that a first end 44 of the stop member 36 is nearly flush with a top surface 46 of the plate 40. A first spring 47 is captured between a ledge 49 on the stop member 36 and the plate 40. The first spring 47 biases the stop member 36 away from the cover 34 (e.g., downward in FIG. 2).

A mass 48 is positioned on the top surface 46 of the plate 40 and includes an opening 50 and a pocket 52. The opening 50 is substantially cylindrical and extends through the entire mass 48 in this example. The pocket 52 is located on a side of the mass 48 opening 50 opposite from the plate 40 and distal from the stop member 36.

A centering member 56, which is a ball in this example, is disposed in the pocket 52. A centering spring 58 is disposed above the centering member 56 and beneath the cover 34. As the centering spring 58 urges the centering member 56 into the pocket 52, the mass 48 is urged into a centered position in the housing as shown in FIG. 2. Under most conditions, the mass 48 remains in this centered position, coaxially aligned with the stop member 36. A coaxial alignment is shown along the axis X.

The first spring 47 biases the stop member 36 into a position where an end 62 contacts the second locking plate 18. The end 62 of the stop member is positioned within a path of movement of the protrusion 20 during actuation of the latching mechanism 10 including rotating the second locking plate 18.

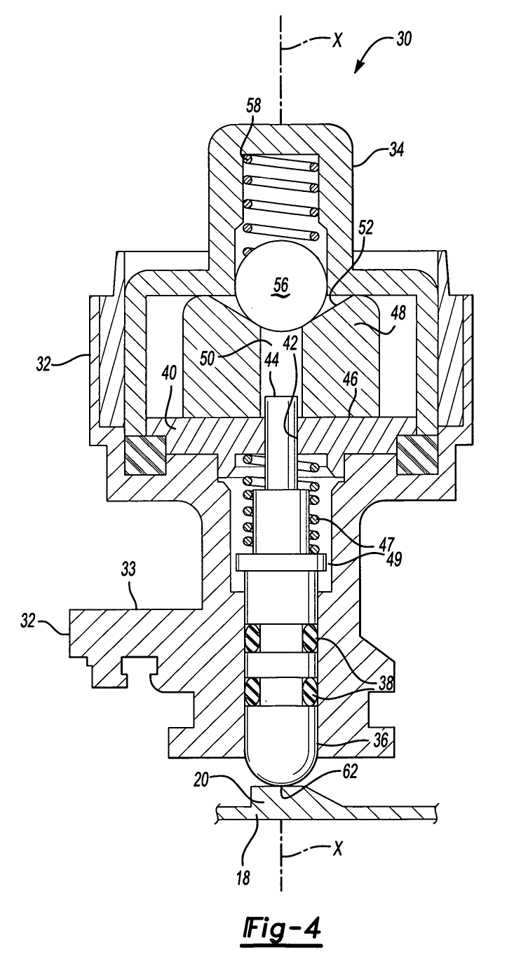

During normal operation, the opening 42 in the plate 40 and the opening 50 in the mass 48 are in alignment. While in this configuration, the stop member 36 can move freely within the housing 32 such that a portion moves through the opening 42 and at least partially into the opening 50. Such movement allows the end 62 to ride along the protrusion 20 as the latching mechanism 10 operates normally to unlock or open a door. This movement can be appreciated by comparing FIGS. 2 and 4.

FIG. 4 shows the stop member end 44 protruding at least partially into the opening 50. In this position, as the mass 48 receives a portion of the stop member 36, the protrusion 20 is free to move for opening the latching mechanism 10.

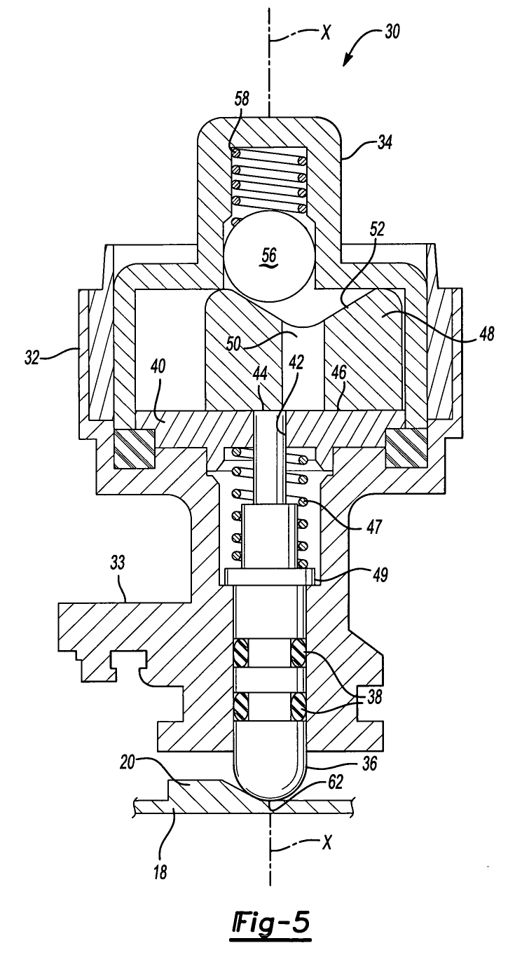

The MILD 30 effectively secures the latching mechanism 10 in a closed position to avoid inadvertent door openings during and immediately following an acceleration or deceleration event such as an impact, for example. During such an event, the weight of the mass 48 overcomes the bias of the centering spring 58 and the mass 48 moves laterally relative to the plate 40. As shown in FIG. 5, such lateral movement of the mass 48 within the cover 34 results in a misalignment of the mass opening 50 and the plate opening 42. When the openings 50 and 42 are not coaxially aligned with the stop member 36, the stop member 36 cannot move relative to the housing 32.

In this condition, the stop member 36 remains extended, such that the end 62 prevents the protrusion 20 and the second locking plate 18 from moving. The protrusion 20 must move (e.g., to the right in FIG. 5) for the latching mechanism 10 to open.

The MILD 30, therefore, prevents the latching mechanism 10 from opening. As such, the example MILD 30 provides a supplemental securing feature for a vehicle closure latching device to prevent undesirable unlatching during abrupt acceleration, deceleration or impact events.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A door latch mechanism comprising:
a stop member; and
a mass member aligned with the stop member in a first position to at least partially receive a portion of the stop member as the stop member moves relative to the mass member during an opening of the latch mechanism, the mass member is moveable into a second position that prevents the stop member from moving.

2. The door latch mechanism as recited in claim 1, including an opening in the mass member aligned with the portion of the stop member in the first position, wherein the opening is offset from the portion in the second position such that the stop member abuts against the mass member.

3. The door latch mechanism as recited in claim 1, including a first spring, that biases the stop member away from the mass member.

4. The door latch mechanism as recited in claim 1, wherein the mass member and the stop member are coaxially aligned in the first position and offset in the second position.

5. The door latch mechanism as recited in claim 1, including a centering member that biases the mass member into the first position.

6. The door latch mechanism as recited in claim 5, wherein the centering member comprises a centering spring and a ball and the mass member includes a contour for at least partially receiving the ball in the first position.

7. The door latch mechanism as recited in claim 5, wherein a weight of the mass member overcomes the centering member bias if the mass member accelerates relative to the centering member.

8. A door latch mechanism comprising:
a stop member; and
a mass member coaxially aligned with the stop member to allow an opening movement of the latch mechanism, wherein a transverse movement of one of the stop member or the mass member relative to the other out of the coaxial alignment prevents the opening movement.

9. The door latch mechanism as recited in claim 8, wherein the mass member includes an opening that partially receives a portion of the stop member during the opening movement.

10. The door latch mechanism as recited in claim 8, including a first spring that biases the stop member away from the mass member.

11. The door latch mechanism as recited in claim 8, including a centering member that biases the mass member into the coaxial alignment with the stop member.

12. The door latch mechanism as recited in claim 11, wherein the mass member includes a contour for receiving at least a portion of the centering member.

13. The door latch mechanism as recited in claim 14, wherein the centering member comprises a centering spring and a ball urged against the mass member by the centering spring.

14. A door latch mechanism comprising:
a stop member;
a mass member;
a ball; and
a spring that biases the ball against the mass member to urge the mass member into a first position to allow relative movement between the stop member and the mass member.

15. The door latch mechanism as recited in claim 14, wherein the stop member is at least partially received within an opening in the mass member during an opening movement of the latch mechanism.

16. The door latch mechanism as recited in claim 14, wherein the mass member is moveable into a second position to prevent the relative movement between the stop member and the mass member when a weight of the mass member overcomes the bias of the spring.

17. The door latch mechanism as recited in claim 14, wherein the mass member moves transverse to an axis of the stop member into the second position.

18. The door latch mechanism as recited in claim 14, wherein the stop member and the mass member are coaxially aligned in the first position.
